(19) United States
(12) Patent Application Publication
(10) Pub. No.: US 2021/0224752 A1
(43) Pub. Date: Jul. 22, 2021

(54) WORK SUPPORT SYSTEM AND WORK SUPPORT METHOD

(71) Applicant: HITACHI, LTD., Tokyo (JP)

(72) Inventors: Mitsuhiro OKADA, Tokyo (JP); Takayuki AKIYAMA, Tokyo (JP); Masaaki YAMAMOTO, Tokyo (JP); Kazu GHALAMKARI, Tokyo (JP); Yasuharu NAMBA, Tokyo (JP)

(73) Assignee: HITACHI, LTD., Tokyo (JP)

(21) Appl. No.: 17/142,840

(22) Filed: Jan. 6, 2021

(30) Foreign Application Priority Data
Jan. 17, 2020 (JP) 2020-006403

(51) Int. Cl. G06Q 10/10; G06Q 40/00; G06K 9/00; G10L 25/51

(52) U.S. Cl. CPC G06Q 10/1091; G06Q 10/1053; G06Q 10/20; G06K 9/00718; G10L 25/51; G06Q 40/125

(57) ABSTRACT

A highly-reliable work report is prepared while reducing the worker's burdens. A work support system 200 prepares a work report by using information including at least a video collected while conducting work. The work support system 200 includes: a work completion recognition unit 240 that judges a completion of the work from the information collected while conducting the work and recognizes completion time of day of the work; a video extraction unit 250 that extracts a video upon completion of the work from the video, which are collected while conducting the work, with reference to the completion time of day of the work; a work recognition unit 260 that recognizes a work item(s) of the work by using the extracted video upon completion of the work; and a work history generation unit 280 that generates a work history of the work in the work report on the basis of recognition results by the work completion recognition unit 240 and the work recognition unit 260.

### TECHNICAL FIELD

The present invention relates to a work support system and a work support method and is suited for application to a work support system and work support method for supporting a series of work including a plurality of work items.

### BACKGROUND ART

Conventionally, a worker who conducts field maintenance work, etc. at their customer's site prepares a work report after completing the work. Various techniques are proposed for the purpose of easily preparing this work report. For example, PTL 1 discloses a “report preparation system characterized by including: a sound recognition means that recognizes sound information about the type of a report which is selected with sound via a portable terminal by a customer engineer and each item required to prepare the report; a report preparation means that prepares the report of the type selected by the customer engineer on the basis of character information obtained as a recognition result of the above-described sound recognition means; and a notification means that notifies a target person who requires the report of the existence of the report prepared by the above-described report preparation means.” Furthermore, PTL 2 discloses a “digital camera equipped with a task report preparation function, which is characterized by including an image capturing means that captures images of a work site regarding each piece of work constituting a task; a setting information acquisition means that acquires task setting information including at least work procedure information and format information for a task report; a guiding means that outputs guiding information to promote camera photographing in accordance with the work procedure information; an achievement information acquisition means that acquires achievement information indicating that the relevant work has been actually conducted, with respect to each piece of work on the basis of the task setting information setting information; a work information storage means that stores and manages the achievement information, which is acquired with respect to each piece of work by the above-described achievement information acquisition means, as information for reporting the work by associating the achievement information with the image captured by the image capturing means; a preparation means that prepares a task report by editing content of the work information storage means according to the set format in accordance with the format information for the task report; and an output means that outputs the task report prepared by the preparation means.

### CITATION LIST

### Patent Literature

PTL 1: Japanese Patent Application Laid-Open (Kokai) Publication No. 2017-122953
PTL 2: Japanese Patent Application Laid-Open (Kokai) Publication No. 2005-286687

### SUMMARY OF THE INVENTION

### Problems to be Solved by the Invention

However, when the work report is input via sound as disclosed by PTL 1, it is necessary to utter with sound all the necessary information for the report such as the work content and the work result and this results in a problem of heavy burdens on the worker. Moreover, since the report is prepared with only utterances of sound, it is possible to prepare the report even if the decided work has not been conducted; and, therefore, there is also a problem of low reliability. Furthermore, PTL 2 discloses the method of capturing images, which serve as work evidence, with the digital camera and automatically attaching the captured images to the work report; however, the worker has to operate the digital camera every time one work item is finished, so that there is a problem of heavy burdens on the worker. Furthermore, if the worker has mistakenly captured images of a work target, there is also a problem of incapability to prevent any omission or failure to conduct the work.

The present invention was devised in consideration of the above-described circumstances and aims at proposing a work support system and work support method capable of preparing a highly-reliable work report while reducing the worker's burdens.

### Means to Solve the Problems

In order to solve the above-described problems, provided according to an aspect of the present invention is a work support system for preparing a work report by using information including at least a video collected while conducting work, wherein the work support system includes: a work completion recognition unit that judges a completion of the work from the information and recognizes completion time of day of the work; a video extraction unit that extracts a video upon completion of the work from the video with reference to the completion time of day of the work; a work recognition unit that recognizes a work item or work items of the work by using the video upon completion of the work which is extracted by the video extraction unit; and a work history generation unit that generates a work history of the work in the work report on the basis of recognition results by the work completion recognition unit and the work recognition unit.

Furthermore, provided according to another aspect of the present invention in order to solve the above-described problems is a work support method for preparing a work report by using information including at least a video collected while conducting work, wherein the work support method includes: a work completion recognition step of judging a completion of the work from the information and recognizing completion time of day of the work; a video extraction step of extracting a video upon completion of the work from the video with reference to the completion time of day of the work; a work recognition step of recognizing a work item or work items of the work by using the video upon completion of the work which is extracted in the video extraction step; and a work history generation step of generating a work history of the work in the work report on the basis of recognition results of the work completion recognition step and the work recognition step.

### Advantageous Effects of the Invention

The highly-reliable work report can be prepared according to the present invention, while reducing the worker's burdens.

### BRIEF DESCRIPTION OF DRAWINGS

FIG. 1 is a block diagram illustrating a configuration example of a work support system according to a first embodiment;

FIG. 2 is an example of a work list for periodical maintenance work for an air conditioner;

FIG. 3A is an example of an external appearance of an outdoor unit for the air conditioner;

FIG. 3B is an example of an external appearance of an outdoor unit for the air conditioner;

FIG. 4 is a flowchart illustrating a progress example of procedures when conducting work which is a target of work support processing of the work support system according to the first embodiment;

FIG. 5 is a diagram illustrating a flow of internal processing of the work support system according to the first embodiment;

FIG. 6 is a diagram illustrating an example of a video upon completion;

FIG. 7 is a diagram illustrating an example of a work report;

FIG. 8 is a diagram illustrating an internal configuration of a work recognition unit according to a third variation;

FIG. 9A is an example of a video upon completion to explain the third variation;

FIG. 9B is an example of a video upon completion to explain the third variation;

FIG. 10 is a diagram illustrating a flow of internal processing of a work support system according to a fourth variation;

FIG. 11 is a diagram illustrating a flow of internal processing of a work support system according to a second embodiment;

FIG. 12 is a block diagram illustrating a configuration example of a work support system according to a third embodiment;

FIG. 13 is a block diagram illustrating a configuration example of a work support system according to a fourth embodiment; and

FIG. 14 is a diagram for explaining a probability judgment of work content according to the fourth embodiment.

### DESCRIPTION OF EMBODIMENTS

Embodiments of the present invention will be explained with reference to the drawings. Incidentally, the same numbers are assigned to components which are common in each drawing and any repetition of explanation will be omitted.

### (1) First Embodiment

### (1-1) Configuration of Work Support System 200

Firstly, the configuration of a work support system 200 according to a first embodiment will be explained. Incidentally, in this embodiment, it is assumed as one example that the work support system 200 operates on a CPU (Central Processing Unit) inside a smartphone possessed by a worker.

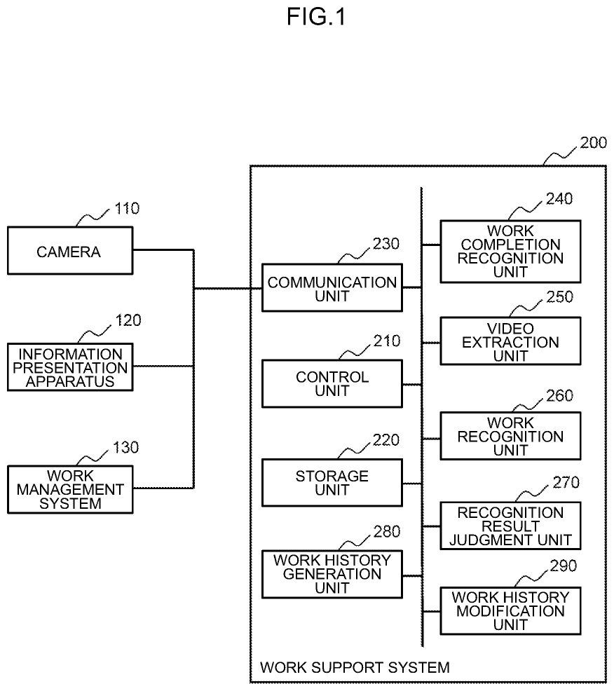

FIG. 1 is a block diagram illustrating a configuration example of a work support system according to a first embodiment. The work support system 200 according to the first embodiment is, as illustrated in FIG. 1, coupled to a camera 110, an information presentation apparatus 120, and a work management system 130 so that they can communicate with each other; and the work support system 200 is configured by including a control unit 210, a storage unit 220, a communication unit 230, a work completion recognition unit 240, a video extraction unit 250, a work recognition unit 260, a recognition result judgment unit 270, a work history generation unit 280, and a work history modification unit 290.

The camera 110 is a camera which the worker wears when working and which has a built-in microphone. Incidentally, as another example of components corresponding to the camera 110, a camera which records a video(s) and a microphone which collects sound may be configured as separate devices; and in this case, they should preferably be in a form capable of responding to time, for example, by causing data collected by both the devices to have time stamps in common.

The information presentation apparatus 120 is an apparatus having an output function via sound or display and presents a work history generated by the work support system 200 (particularly, the work history generation unit 280) to the worker. Specifically speaking, for example, the information presentation apparatus 120 may be a speaker which presents information via the sound to the worker or may be smart glasses or the like which presents the information via an AR (Augmented Reality) display to the worker.

The work management system 130 is a system for comprehensively managing the information about the work and manages, for example, work plans, work histories (work reports), and so on of all workers.

The internal configuration of the work support system 200 will be explained in detail. The respective units inside the work support system 200 illustrated in FIG. 1 show a functional configuration example of the work support system 200 and are not limited to independent components in terms of hardware. Regarding a specific hardware configuration example, assuming that the work support system 200 is a system which operates on a smartphone, the communication unit 230 is implemented by a communication interface for the smartphone. Also, the storage unit 220 is implemented by a memory (recording medium) mounted in or connected to the smartphone. Furthermore, other units, that is, the control unit 210, the work completion recognition unit 240, the video extraction unit 250, the work recognition unit 260, the recognition result judgment unit 270, the work history generation unit 280, and the work history modification unit 290 are implemented by the CPU mounted in the smartphone reading and executing specified programs stored in the memory.

The control unit 210 has a function that controls the entire work support system 200.

The storage unit 220 stores data which are treated by the work support system 200. For example, work lists, work reports, and so on are recorded in the storage unit 220.

The communication unit 230 has a function that transmits/receives information to/from an apparatus coupled to the work support system 200 so that they can communicate with each other. For example, the communication unit 230 receives a video(s) with sound, which is recorded by the camera 110, and transmits the processing result (the work history) by the work history generation unit 280 to the information presentation apparatus 120; and besides the above, the communication unit 230 transmits/receives specified information to/from the work management system 130.

The work completion recognition unit 240 has a function that judges the completion of the work by identifying an utterance indicating the completion of the work (a completion utterance) from sounds during the work, which are collected by the camera 110 (the details will be explained later), and recognizes completion time of day of the relevant work.

The video extraction unit 250 has a function that cuts out a video to be input to the work recognition unit 260 (a video upon completion), from the video(s) during the work which have been recorded by the camera 110, on the basis of the completion time of day of the work which is identified by the work completion recognition unit 240.

The work recognition unit 260 has a function that recognizes the work which has been completed (a work item), from the video upon completion which has been cut out by the video extraction unit 250. In more detail, the work recognition unit 260 recognizes a target object of the completed work by executing specified recognition processing on the video upon completion and estimates a work item (which may be read as work content) corresponding to the target object by searching a check list relating to each work included in the series of work (a work list 310 described later) by using the recognition result of the target work as a key.

The recognition result judgment unit 270 has a function that receives an input from the work recognition unit 260 and judges whether or not the video upon completion, which has been cut out by the video extraction unit 250, is appropriate as a video indicating the work of the work item recognized by the work recognition unit 260. The recognition result judgment unit 270 may judge whether video data is normal or abnormal by, for example, judging the status of the video data to check if the video upon completion is blurry or not or, for example, judging the content of the video data to check if meter values and a model number, etc. of a name place, which are indicated in the video upon completion, match setting items of the work list 310. To read the meter values, the model number, and so on, for example, an OCR (Optical Character Recognition) function may be used. Incidentally, the recognition result judgment unit 270 provides expansive functions and the work support system 200 may be configured to not include this.

The work history generation unit 280 has a function that generates the work history on the basis of the recognition results of the work completion recognition unit 240 and the work recognition unit 260. The details will be explained later, but the work history generation unit 280 prepares a work report of the entire work conducted by the worker by generating a work history of each piece of work conducted by the worker. Moreover, the work history generation unit 280 presents the generated work history (work report) to the worker and a work administrator by transmitting the generated work history (work report) to the information presentation apparatus 120 and the work management system 130 via the communication unit 230. The information which is presented by the work history generation unit 280 to the worker and the work administrator may be a part of the generated work history or, in other words, may be specified information (a sound output indicating “the completion of the name plate check is recognized” in a specific example explained later) based on the recognition results of the work completion recognition unit 240 and the work recognition unit 260 which are used to generate the work history.

The work history modification unit 290 has a function that modifies the target work history (work report) according to a modification action when the worker performs the modification action by issuing the instruction to the modify the work history (the work report) generated by the work history generation unit 280, by using the camera 110 and the information presentation apparatus 120. Incidentally, the work history modification unit 290 provides expansive functions and the work support system 200 may be configured to not include this.

### (1-2) Processing by Work Support System 200

Next, work support processing by the work support system 200 according to this embodiment will be explained in detail. Incidentally, the work support system 200 can set not only work composed of a single work item, but also a series of work including a plurality of work steps (or work items) as a target(s) of the work support processing; and in the following explanation, periodical maintenance work for an air conditioner will be taken and explained as a specific example of such a series of work. Furthermore, in the following explanation, the series of work may be sometimes referred to as the “entire work” and each work step (or work item) may be sometimes referred to as the “work” for the sake of convenience.

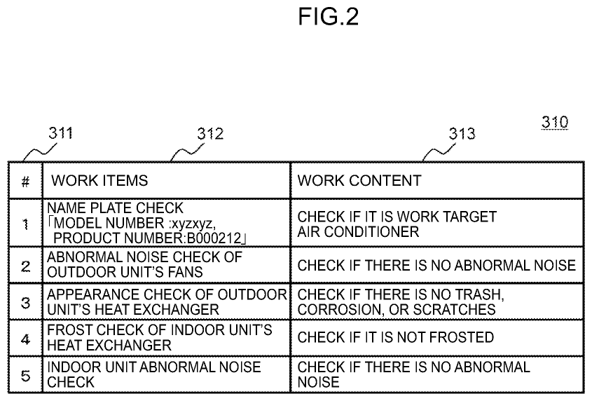

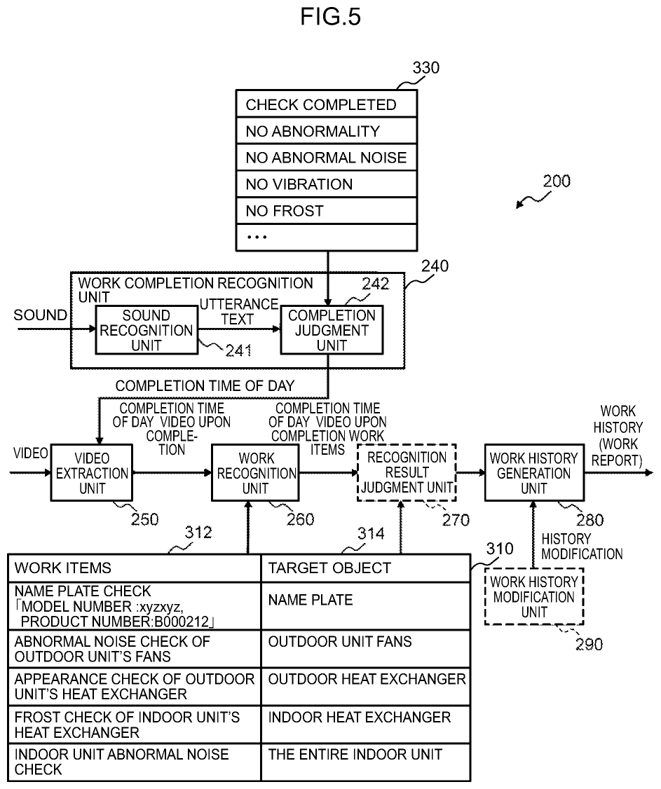

FIG. 2 is an example of a work list for periodical maintenance work for an air conditioner. Regarding the periodical maintenance work for the air conditioner, it is necessary to conduct a plurality of pieces of work in the entire work and specified information is summarized in the work list 310 in FIG. 2 with respect to each piece of work included in the periodical maintenance work for the air conditioner. Specifically speaking, the work list 310 is composed of a work number (#) 311 indicating the sequential order to conduct recommended work, work items 312 indicating the outline of the work, work content 313 indicating the specific content of the work, and target objects 314 which are targets of the work (the target objects are not illustrated in FIG. 2; see FIG. 5), and so on.

The work list 310 is registered in the work management system 130 in advance, is transmitted to the work support system 200, and is also stored in the storage unit 220. Incidentally, when work lists for various entire work are managed by the work management system 130, only the work list 310 regarding work which is to be conducted now (for example, the periodical maintenance work for the air conditioner) may be transmitted to the work support system 200 and stored in the storage unit 220.

When the periodical maintenance work for the air conditioner is conducted in accordance with the work list 310 in FIG. 2, specifically speaking, the work of the fifth item is conducted among the following work items indicated in the work item 312: “NAME PLATE CHECK,” “ABNORMAL NOISE CHECK OF OUTDOOR UNIT'S FANS,” “APPEARANCE CHECK OF OUTDOOR UNIT'S HEAT EXCHANGER,” “FROST CHECK OF INDOOR UNIT'S HEAT EXCHANGER,” and “INDOOR UNIT ABNORMAL NOISE CHECK.” Incidentally, it is also presumed that no recommended sequential order to conduct the work may exist depending on the type of the entire work; and in this case, the work number 311 is registered in an arbitrary sequential order.

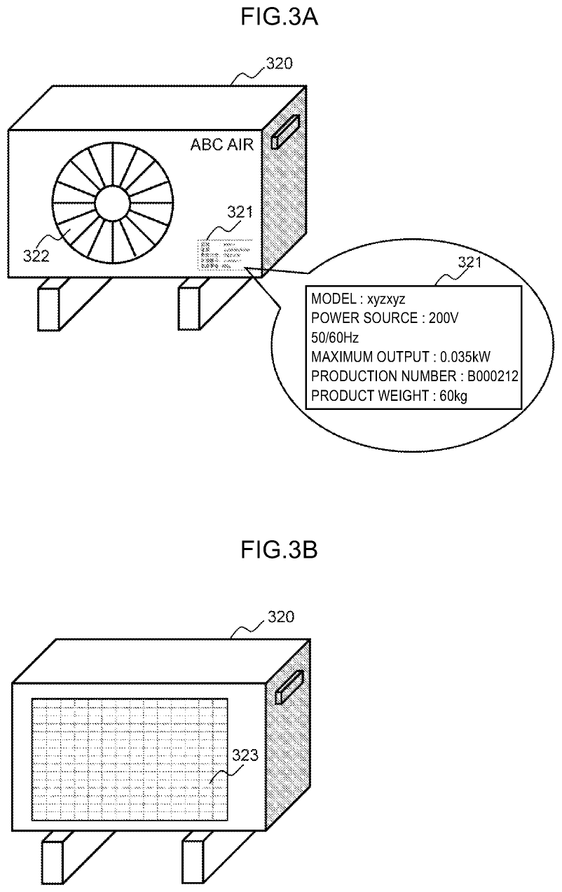

FIG. 3 is an example of an external appearance of an outdoor unit for the air conditioner. FIG. 3A is a diagram as viewed from the front (or front side) of an outdoor unit 320 of the air conditioner and FIG. 3B is a diagram as viewed from the back (or back side) of the outdoor unit 320 of the air conditioner. The outdoor unit 320 illustrated in FIG. 3 corresponds to the outdoor unit of the work target in the work list 310 in FIG. 2. As illustrated in FIG. 3A, a vent for fans 322 is provided at the center of the front side of the outdoor unit 320 and a name plate 321 on which specifications of the air conditioner are described is attached to the lower right of the front side of the outdoor unit 320. Furthermore, as illustrated in FIG. 3B, a heat exchanger 323 for transferring heat via a refrigerant between the outside and the inside is installed on the back side of the outdoor unit 320.

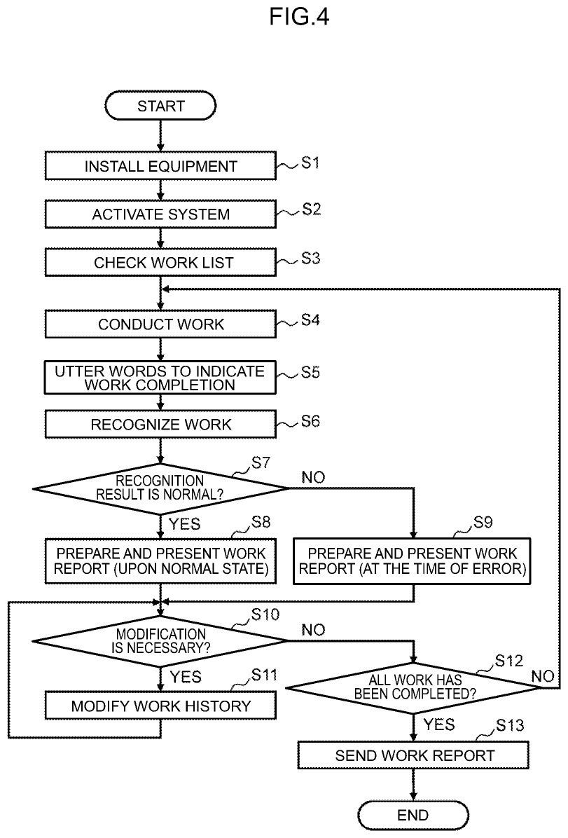

FIG. 4 is a flowchart illustrating a progress example of procedures when conducting work which is a target of work support processing of the work support system according to the first embodiment. The respective procedures in FIG. 4 will be explained below by taking the periodical maintenance work for the air conditioner as an example of the target work of the work support processing.

Referring to FIG. 4, when the worker arrives at a work site to conduct the periodical maintenance work for the air conditioner, the worker firstly wears the camera 110 and the information presentation apparatus 120 on their body (step S1). The place to mount the camera 110 may be any position where a video during the work can be recorded, such as beside their ear, on their head, or on their chest. Furthermore, the information presentation apparatus 120 may be any apparatus such as a speaker or smart glasses capable of presenting the information to the worker as explained earlier.

Next, the worker activates the work support system 200 (step S2). Once the work support system 200 is activated, the control unit 210 starts controlling each of other blocks (the communication unit 230, the work completion recognition unit 240, the work recognition unit 260, the video extraction unit 250, the storage unit 220, and the work history generation unit 280).

Regarding the specific details of the above-mentioned control, the control unit 210 firstly activates the communication unit 230, downloads the work list 310 (see FIG. 2) of the series of work to be conducted at the current work site, and stores it in the storage unit 220. Then, the control unit 210 connects to the camera 110 by using the communication unit 230 and sends an instruction from the communication unit 230 to the camera 110 to start recording a video. Incidentally, communication means and communication standards used by the communication unit 230 to communicate with the camera 110, the information presentation apparatus 120, and the work management system 130 are not particularly limited and, for example, Wi-Fi (registered trademark), Bluetooth (registered trademark), LTE (Long Term Evolution) (registered trademark) lines, or wired LAN (Local Area Network) connections can be used. Also, the communication unit 230 may change the communication means and the communication standards with respect to each device to be connected. Then, once the camera 110 starts recording a video, the video and sound during the work are input in real time to the work support system 200 via the communication unit 230.

Next, the worker recognizes the work item 312 and the work content 313 of each piece of work to be conducted as the periodical maintenance work by checking the work list 310 (step S3). Incidentally, a means for the worker to check the work list 310 is not limited. For example, the work list 310 downloaded by the control unit 210 from the work management system 130 in step S2 may be transmitted from the communication unit 230 to the information presentation apparatus 120 and the work list 310 received by the information presentation apparatus 120 may be displayed for the worker. Alternatively, a piece of paper on which the content of the work list 310 is output may be handed to the worker in advance to let the worker carry that paper.

Subsequently, the worker starts conducting the work on the basis of the check result of the work list 310 in step S3 (step S4). In this embodiment, the worker conducts the plurality of pieces of work, which are registered in the work list 310, one by one; and every time one piece of work is completed, the worker utters words indicating the completion of the work (step S5).

Specifically speaking, for example, when the work list 310 in FIG. 2 is used, the sequential order to carry out the respective pieces of work is defined in the work number 311 and, therefore, the worker performs the “name plate check” which is the first work in the first step S4. Regarding the work of this name plate check, the worker visually checks, for example, the items indicated on the name plate 321 attached to the lower right of the front side of the outdoor unit 320 in FIG. 3; and after the worker checks that a model number (model) is “xyzxyz” and a production number is “B000212,” the worker utters “check completed” while watching the name plate 321. In this example, the words “check completed” are defined as one of work completion utterances (see a completion utterance list 330 in FIG. 5).

Then, as triggered by the work completion utterance by the worker in step S5, the work completion recognition unit 240 for the work support system 200 recognizes the completion of the work (the completion time of day) and the work recognition unit 260 recognizes the content of the relevant work (the work item and the work content) (step S6).

FIG. 5 is a diagram illustrating a flow of internal processing of the work support system according to the first embodiment. Step S6 and subsequent steps are processing mainly by the respective units of the work support system 200, so that a detailed explanation will be provided by referring to FIG. 5.

The work completion recognition unit 240 is configured by including a sound recognition unit 241 and a completion judgment unit 242 as illustrated in FIG. 5. Furthermore, the work list 310 (which is similar to that in FIG. 2) and the completion utterance list 330 which are illustrated in FIG. 5 are stored in the storage unit 220.

The sound during the work is always input from the camera 110 to the work completion recognition unit 240. When the completion utterance is made by the worker in step S5, the work completion recognition unit 240 judges the completion of the work by identifying the completion utterance from the sound in step S6.

Specifically speaking, the sound recognition unit 241 firstly converts the sound, which has been input from the camera 110, into text by using a known sound-text conversion technology. The converted text will be hereinafter referred to as the utterance text. Next, the completion judgment unit 242 performs a partial match retrieval of the completion utterance list 330, which is stored in the storage unit 220, by using the utterance text generated by the sound recognition unit 241; and if any matching completion utterance exists, the completion judgment unit 242 determines that the work has been completed. Under this circumstance, the completion judgment unit 242 transmits the present time of day (which may be read as the time of day when the completion utterance is made) as work completion time of day to the video extraction unit 250.

The completion utterance list 330 is a list in which a list of words indicating the completion of the work (completion utterances) is registered in advance. Various completion utterances can be registered in the completion utterance list 330. For example, in the case of the completion utterance list 330 illustrated in FIG. 5, the completion utterances such as “check completed” and “no abnormality” are completion utterances which can be generally used regardless of the types of the work items. Furthermore, the completion utterances such as “no abnormal noise” and “no vibration” are completion utterances corresponding to specific work items such as the abnormal noise check and a vibration abnormality check.

Incidentally, various completion utterances can be registered in the completion utterance list 330 without limitation to the above-mentioned examples. For example, a completion utterance to be made when any abnormality is recognized in the work (for example, “there is abnormality”) may also be registered. In this case, the work support system 200 may executed specified processing for recording the abnormality (for example, by recording, manually or with sound, the error content in a note section of the work report) as triggered by the completion utterance regarding abnormality uttered during the work. Moreover, regarding the completion utterance list 330, the list to be used may be switched depending on the work target (such as an air conditioner, a launderette, and so on) of the entire work. Furthermore, the worker may customize the completion utterance list 330 by adding and setting their own favorite phrases.

Furthermore, the method of having the completion judgment unit 242 identify the completion utterance from the utterance text is not limited to the above-described method of using the completion utterance list 330 in which the completion utterances are registered; and, for example, the completion judgment unit 242 may be designed to be capable of directly identifying the completion utterances from the uttered sound during the work (or the utterance text after the conversion) by having the work completion recognition unit 240 learn the completion utterances by means of deep learning, for example, by repeating learning to distinguish the completion utterances from other natural utterances with respect to the sound collected from the camera 110 (which may also be the utterance text after the conversion).

A video(s) during the work is always input from the camera 110 to the video extraction unit 250. The video extraction unit 250 extracts a video at the completion time of day as triggered by the reception of the completion time of day from the work completion recognition unit 240 (the completion judgment unit 242). Then, the video extraction unit 250 transmits the extracted video (the video upon completion) together with the completion time of day to the work recognition unit 260.

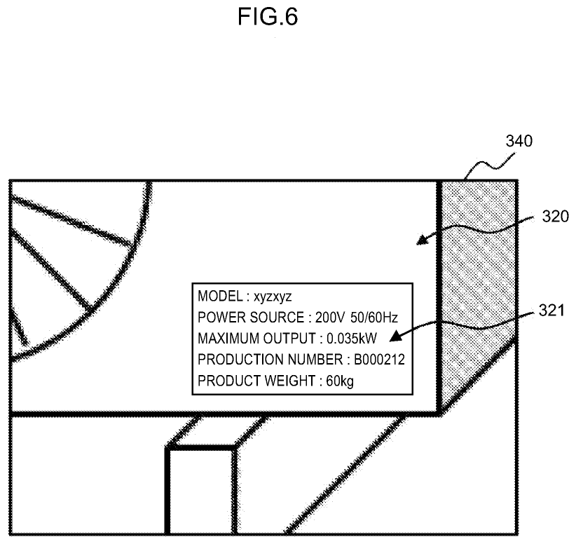

FIG. 6 is a diagram illustrating an example of the video upon completion. An image 340 illustrated in FIG. 6 is an example of the video upon completion which is extracted by the video extraction unit 250 as triggered by the completion utterance of the work of the “name plate check.” A part of the outdoor unit 320 is captured in this image 340 and the name plate 321 is shown at the center part of the image 340.

The work recognition unit 260 performs object recognition with respect to the video upon completion received from the video extraction unit 250 by using a recognition model, which was learned in advance, and recognizes the target object corresponding to the work which is described in the work list 310, thereby identifying the work item. For example, when the work of the “name plate check” has been conducted, and assuming that the image 340 in FIG. 6 is extracted by the video extraction unit 250 as triggered by the utterance saying “check completed,” it is possible to interpret that the work item of the “name plate check” has been completed if the name plate 321 which is shown in the image 340 is output as the result of the object recognition. Then, the work recognition unit 260 transmits the specified work item, together with the completion time of day and the video upon completion (the image 340 in this example) which have been received from the video extraction unit 250, to the recognition result judgment unit 270 (or the work history generation unit 280 if the recognition result judgment unit 270 is not included).

Incidentally, the work recognition unit 260 performs the object recognition by applying an existing object recognition method such as YOLO (You Only Look Once). Specifically speaking, an existing object recognition model cannot be directly used to recognize the target object which is required to specify the work item. Accordingly, a large number of images of the target object which needs to be recognized are collected and images are prepared as an advance preparation by tagging a bounding box and an object name as correct solution values to each of the above-collected images. The target object described in the work list 310 can be recognized by conducting fine tuning of the object recognition model by using this tagged image.

Next, after receiving the output from the work recognition unit 260, the recognition result judgment unit 270 judges whether the work recognition result in step S6 is normal or not (step S7). Specifically speaking, the recognition result judgment unit 270 judges whether or not the video upon completion is an appropriate video indicating the work of the work item, on the basis of the information input from the work recognition unit 260 (particularly, the video upon completion and the work item) and the work list 310.

If it is determined in step S7 that the work recognition result is normal (YES in step S7), the recognition result judgment unit 270 transmits the normal judgment result and the information, which was input from the work recognition unit 260, to the work history generation unit 280. Then, the work history generation unit 280 records the work history of the target work, regarding which the work recognition was performed, in the work report (prepares the work report upon normal state) on the basis of the information which was input from the recognition result judgment unit 270 (the normal/abnormal judgment result, the completion time of day, the video upon completion, and the work item) and further presents the information of the prepared work report to the information presentation apparatus 120 via the communication unit 230 (step S8).

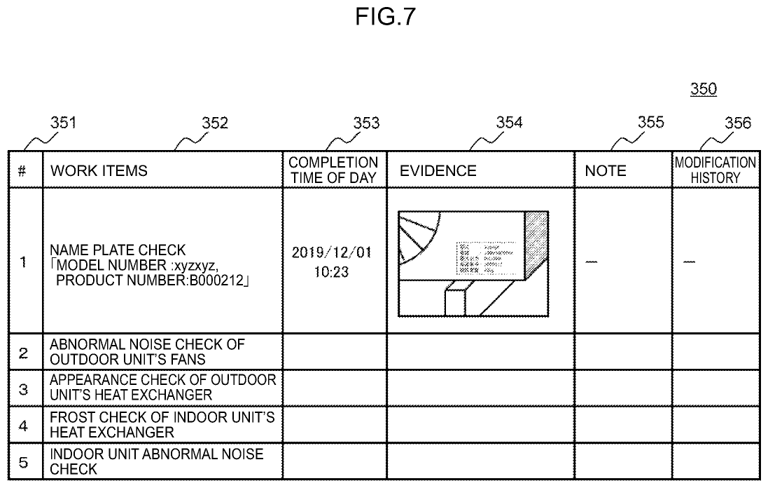

FIG. 7 is a diagram illustrating an example of the work report. A work report 350 illustrated in FIG. 7 is an example of the work report prepared when conducting the periodical maintenance work for the air conditioner in accordance with the work list 310 illustrated in FIG. 2 and shows the work report of the stage where the “name plate check” which is performed firstly in the periodical maintenance work for the air conditioner has been completed.

In the case of FIG. 7, the work report 350 is composed of a work number (#) 351, a work item 352, completion time of day 353, an evidence 354, a note 355, and a modification history 356. Among these pieces of information, the work number 351 and the work item 352 describe the same content as that of the work number 311 and the work item 312 of the work list 310 in FIG. 2. The completion time of day 353 describes the completion time of day recognized by the work completion recognition unit 240 as the completion time of day of the work of the relevant record. The video upon completion (or a part thereof) extracted by the video extraction unit 250 as a record of the conducted work of the relevant record is embedded in the evidence 354.

When a partial image included in the video upon completion is to be embedded in the evidence 354, the work history generation unit 280 may select an image which is less blurry, from the video upon completion. The quality of the work report 350 may be enhanced by setting the image which is less blurry, as the evidence 354 of the work report 350. Records of errors which have occurred in the processing executed so far, special remarks which are manually recorded, and so on are described in the note 355. The modification history 356 describes whether the work history generated by the work history generation unit 280 with respect to the work of the relevant record has been modified by the worker or not.

Furthermore, in step S8, the work history generation unit 280 outputs the information based on the prepared work report (the work history) from the information presentation apparatus 120 and presents it to the worker. For example, if the information presentation apparatus 120 is designed to report with sound, for example, that “the completion of the name plate check has been recognized,” the worker can tell that the work support system 200 has certainly recognized the completion of the work and has automatically generated the work history; and, therefore, the worker can feel reassured and proceed to the next work. Furthermore, for example, the information presentation apparatus 120 may be designed to display and output the work report 350; and in this case, the worker can check what kind of work history has been generated.

On the other hand, if it is determined in step S7 that the work recognition result is abnormal (NO in step S7), the recognition result judgment unit 270 transmits the abnormal judgment result and the information, which was input from the work recognition unit 260, to the work history generation unit 280. Then, the work history generation unit 280 records an error record in the work report 350 (prepares a work report at the time of error occurrence) as the work history of the target work, regarding which the work recognition was performed, on the basis of the information which was input by the recognition result judgment unit 270 (the normal/abnormal judgment result, the completion time of day, the video upon completion, and the work item) and further presents the information of the work history created in the work report 350 to the information presentation apparatus 120 via the communication unit 230 (step S9).

The preparation of the work report at the time of error occurrence in step S9 will be explained below. The work history generation unit 280 describes the completion of time of day of the target work in the completion time of day 353 and embeds the video upon completion (or a part thereof) of the target work in the evidence 354 in a manner similar to the method of creating the work report upon normal state (step S8). Furthermore, the work history generation unit 280 describes, as unique processing at the time of error occurrence, in the note 355 of a record of the target work that the video upon completion has an error. A method for describing the error is not particularly limited and the detailed content of error may be described by stating, for example, “the evidence is blurry” or “the model number on the name plate does not match.”

Then, when the work report at the time of error occurrence is prepared, the work history generation unit 280 outputs the information based on the prepared work report (the work history) from the information presentation apparatus 120 and presents it to the worker. A specific presentation method may be similar to the method for presenting the work report upon normal state as explained in step S8. Since it is possible to report in real time the failure to recognize the work appropriately by presenting the information at the time of error occurrence to the worker as described above, the worker can deal with the situation at an early stage by, for example, redoing the work or modifying the work report and, therefore, the effect of suppressing an increase in the overall work time and troublesome work can be expected.

Incidentally, the processing sequence in FIG. 4 is designed so that if the judgment result by the recognition result judgment unit 270 is abnormal (NO in step S7), the work history generation unit 280 prepares the work report at the time of error occurrence (step S9); however, error processing may be executed in a different sequence from that of step S9. Specifically speaking, for example, the error may be reported by the information presentation apparatus 120 without preparing the work history of the target work in the work report 350. After receiving this error report, the worker can manually describe the work history in the work report 350 or redo the target work.

Next, after receiving the presentation of the work report 350 in step S8 or step S9, the worker judges whether it is necessary to modify the work history of the target work or not (step S10). Under this circumstance, the worker who wishes to carry out the modification gives the instruction to modify the work report 350 by causing the information presentation apparatus 120 to perform a specified modification action. If there is a mistake in the recognition result, for example, if the work of the name plate check has been conducted while watching the name plate 321, but the work history of another work whose target object is the heat exchanger 323 has been prepared, the worker gives the instruction to modify the error by uttering words with sound such as “Wrong, the name plate check.” Also, for example, the modification instruction may be given by inputting the modification content to the work report 350 displayed on the information presentation apparatus 120.

In response to the above-described modification action by the worker, the work history modification unit 290 on the work support system 200 side modifies the work history (the work report 350) according to the content of the modification action (step S11). For example, if the heat exchanger 323 is mistakenly recognized instead of the name plate 321 and the modification instruction is given with sound by stating “Wrong, the name plate check,” the utterance to modify the history (“Wrong” in the above-described example) and the content of the modification instruction which follows the above utterance (“the name plate check” in the above-described example) can be recognized, respectively, by separately preparing an utterance list for modifying the history, to which the sound recognition unit 241 can refer, to recognize the modification instruction with sound and providing a processing unit that has a function recognizing a partial match with the above-described list. The work history modification unit 290 can modify the record of the “name plate check” in the work report 350 on the basis of this recognition result.

If the work history modification unit 290 modifies the work report (the work history) in step S11, the modified work report should preferably be presented by the information presentation apparatus 120 to the worker. By presenting the modified work report, the worker can check whether the instructed modification is reflected in the work report 350 or not; and if there is any insufficient point, the worker can give the modification instruction again.

Furthermore, if the work history modification unit 290 modifies the work report 350, the modification should preferably be recorded in the relevant record of the work history in the work report 350 (the modification history 356 in FIG. 7). By recording the modification, it is possible to judge whether the description content of the work report 350 is the result automatically generated by the system or the result modified by the worker, so that the record of the modification can be used for management and evaluation by the work administrator. For example, the work administrator can check only the modified item of the work report 350 and verify whether the modification has been appropriate or not. Furthermore, for example, if the cause of the modification is a misrecognition by the system, the modified data can be used as teacher data for relearning a work recognition model and, therefore, it can be used to enhance a recognition rate of the work recognition unit 260.

On the other hand, if it is determined in the judgment in step S10 that the presented modification of the work report 350 is unnecessary (NO in step S10), the control unit 210 judges whether all the work to be conducted as the periodical maintenance work has been completed or not (step S12). Specifically speaking, for example, the control unit 210 judges whether the entire work has been conducted or not, by checking the work report 350 prepared by the work history generation unit 280 against the work list 310 checked in step S3 and thereby checking whether the work history of the entire work has been created or not. Furthermore, for example, when the worker utters a specified completion utterance “the entire work is finished” indicating the completion of the entire work and the work completion recognition unit 240 recognizes this completion utterance, it may be determined that the entire work has been conducted.

Then, if it is determined in step S12 that some work remains to be conducted as the periodical maintenance work (NO in step S12), the processing returns to step S4 and the worker starts conducting one piece of work (for example, the second work which is an abnormal noise check of the outdoor unit's fans) among the remaining work. The work report 350 in which the work history of the entire work of the periodical maintenance work has been created is prepared by repeating the above-described processing.

Then, if it is determined in step S12 that the entire work of the periodical maintenance work has been completed (YES in step S12), the control unit 210 or the work history generation unit 280 transmits the final work report 350 to the work management system 130 via the communication unit 230, thereby completing the periodical check work.

Incidentally, when the control unit 210 (or the work history generation unit 280) checks the content of the work report 350 by comparing it with the work list 310 at an arbitrary timing (for example, every time the work history about one piece of work is generated) and if the work report 350 indicates any work which failed to be conducted, or any mistake in the sequential order to conduct the work, the worker may be informed to that effect by, for example, outputting an alert to the information presentation apparatus 120. Since the worker can be informed of the omission or failure to conduct the work at an early stage by executing the above-described processing, the effect of suppressing, for example, moving the work site again or redoing prework in association with the implementation of the omitted or failed work and suppressing an increase of the entire work time can be expected.

When the worker wears the camera 110 and conducts a series of work including the plurality of work steps as explained above, the work support system 200 according to this embodiment can automatically prepare a highly-reliable work report as triggered by a simple utterance indicating the completion of the relevant work step (the completion utterance) by making that completion utterance at the completion of each work step. In other words, the work support system 200 according to this embodiment can prepare the highly-reliable work report while reducing the worker's burdens.

Furthermore, the work support system 200 according to this embodiment specifies the work item by means of the video recognition, so that it can guarantee that the completion utterance has been made in the situation where the target equipment is treated at the site. Therefore, as compared to the case of the automatic input only with the sound and the case of the manual input by the worker, the reliability as the evidence of implementation of the work can be enhanced. Also, this evidence can be embedded and output in the work report (the evidence 354 in FIG. 7), so that the reliability can be further enhanced.

Furthermore, regarding the work support system 200 according to this embodiment, the work history (the work report 350) prepared by the work history generation unit 280 is presented to the worker every time the completion of one work step is recognized; and, therefore, even if the work support system 200 fails to recognize or misrecognize the completion of the work step, it is possible to carry out the modification promptly and recover the error of the work report 350.

### (1-3) Variations

Incidentally, the work support system 200 according to this embodiment is not limited to the above-described configuration and processing sequence, but can adopt various variations explained below. These variations may be combined as necessary and may further be adopted in second and third embodiments of the present invention described later.

### (1-3-1) First Variation

FIG. 1 illustrates the camera 110 and the work support system 200 as independent components and shows the internal configuration of the work support system 200; however, the system configuration according to this embodiment is not limited to this system configuration. For example, although it has been described that the work support system 200 operates on the smartphone possessed by the worker, the work support system 200 according to this embodiment may be designed so that a part or whole of it may operate on a device other than the smartphone, that is, a tablet terminal, a notebook PC, cloud, or the like.

One example of a method for implementing the work support system 200 by using the cloud will be explained specifically. For example, if the camera 110 is equipped with an LTE line connector capable of wireless communication using LTE lines and a microphone which also functions as the information presentation apparatus 120, the video(s) and sound which are collected by the camera 110 during the work may be uploaded to the cloud by using the LTE lines and all operations of the work support system 200 may be executed on the cloud. Furthermore, in the case of the above-described configuration, the worker can listen to the recognition result from the microphone of the camera 110 by transmitting the work recognition result by the work recognition unit 260 from the cloud to the camera 110.

Furthermore, as another example of the method for implementing the work support system 200 by using the cloud, the work completion recognition unit 240 and the video extraction unit 250 may be designed to operate on the smartphone and the processing until the extraction of the video upon completion by the video extraction unit 250 may be executed on the smartphone and the completion time of day and the video upon completion may be uploaded to the cloud. In recent years, the enhancement of the performance has enabled a mobile terminal such as the smartphone to recognize images, but their recognition accuracy is not sufficient yet. On the other hand, to upload all the collected video(s) and sound to the cloud brings about concerns about a sudden rise in communication line cost. So, by adopting such a configuration that data obtained by executing the processing until the processing by the video extraction unit 250 is uploaded to the cloud, the subsequent processing by the work recognition unit 260 is executed on the cloud, and only the recognition result is returned to the smartphone, it is possible to realize the configuration in consideration of both the reduction of the communication line cost and the enhancement of the recognition accuracy.

### (1-3-2) Second Variation

An explanation will be provided about a variation of the extraction of the video upon completion by the video extraction unit 250. In the aforementioned explanation of the work support system 200, the image 340 (see FIG. 6) which is one image extracted at the completion time of day from the video recorded by the camera 110 is taken as an example of the video upon completion which is extracted by the video extraction unit 250; however, the extraction of the video upon completion by the video extraction unit 250 is not limited to this example.

For example, the video extraction unit 250 may extract a plurality of images or a short-time video as the video upon completion. When the plurality of images or the short-time video is to be extracted, they or it should preferably be extracted with reference to the completion time of day and from a time slot around the completion time of day (particularly, at or before the completion time of day). For example, if the video extraction unit 250 extracts a plurality of images (or videos) taken during a few seconds at or before the completion time of day from the video recorded by the camera 110, the work recognition unit 260 can perform the object recognition with respect to all frames of the extracted images. In this case, if the work recognition unit 260 fails to recognize the objects in one image, it can perform the object recognition by using the recognition results of the past frames. So, it is possible to enhance the work item recognition accuracy. Specifically speaking, if time-series image information is used as the video upon completion, there is a problem of an increase in computation, but the effect of enhancing the work item recognition accuracy can be expected.

Furthermore, for example, a model video (which may be an image) recorded at the completion of the work as an optimum video may be prepared in advance for each work item and the video extraction unit 250 may extract a video taken at the timing with the highest similarity to the model video as the video upon completion, from a video recorded by the camera 110 during a specified period of time retroactively from the completion time of day. Regarding the calculation of the video (image) similarity, for example, a known method such as feature point matching can be used. When the video upon completion is extracted by using the model video as described above, the video upon completion which is to be embedded in the work report 350 would be the one which is similar to the model video. So, the quality of the work report 350 can be enhanced. Furthermore, as the video upon completion which is close to the model video is extracted, the effect of enhancing the work item recognition rate by the work recognition unit 260 can also be expected.

Furthermore, when extracting the video upon completion, the video extraction unit 250 may be designed to select a less blurry image as the video upon completion from among the plurality of images extracted with reference to the completion time of day. By selecting the less blurry image as the video upon completion, the work item recognition rate by the work recognition unit 260 can be enhanced.

### (1-3-3) Third Variation

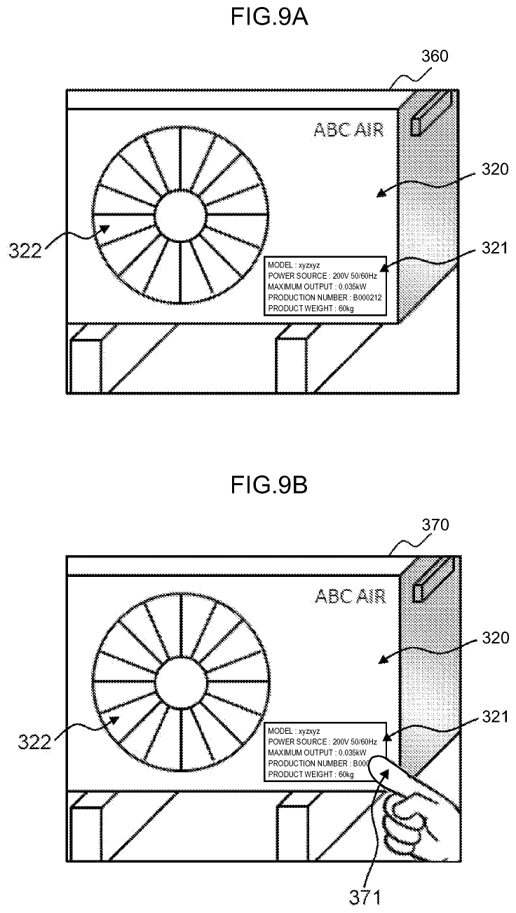

A work recognition unit 261 will be explained as a variation of the work recognition unit 260. In the aforementioned explanation of the work support system 200, the work recognition unit 260 estimates (or recognizes) the work item by performing the object recognition with respect to the video upon completion, which is extracted by the video extraction unit 250 from the video(s) recorded during the work, and searching the work list on the basis of the target object recognition result. However, for example, if a plurality of target objects appear in the video upon completion as in an image 360 described later in FIG. 9A, there is a possibility that the work recognition unit 260 may not be able to uniquely identify the work item by means of the object recognition of the video upon completion. The third variation is effective in solving such a problem and the work recognition unit 261 is adopted instead of the work recognition unit 260.

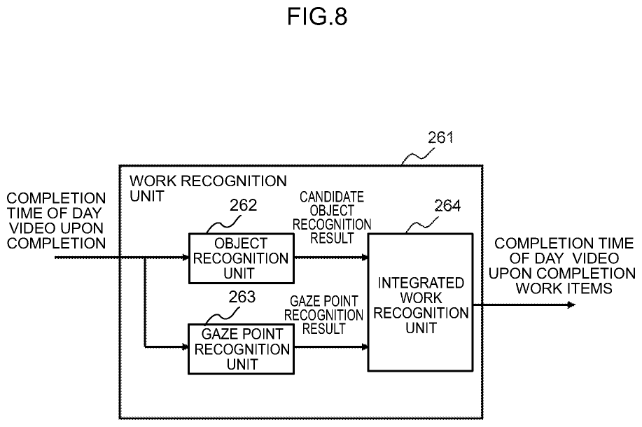

FIG. 8 is a diagram illustrating an internal configuration of the work recognition unit according to the third variation. The work recognition unit 261 is configured by including an object recognition unit 262, a gaze point recognition unit 263, and an integrated work recognition unit 264 as illustrated in FIG. 8.

The object recognition unit 262 has a function that recognizes a candidate object for the target object of the work from the video upon completion which has been cut out by the video extraction unit 250. The gaze point recognition unit 263 has a function that recognizes a predetermined specific gaze point (pointing with an index finger in this example) from the video upon completion which has been cut out by the video extraction unit 250. The integrated work recognition unit 264 has a function that estimates the work item on the basis of the recognition results of the object recognition unit 262 and the gaze point recognition unit 263.

A flow of processing by the work recognition unit 261 will be explained. Firstly, the video upon completion, which has been extracted by the video extraction unit 250, is input to the object recognition unit 262 and the gaze point recognition unit 263, respectively.

The object recognition unit 262 recognizes an object which becomes a candidate for the target object of the work (a candidate object), by executing specified recognition processing on the input video upon completion and outputs the recognition result of the candidate object to the integrated work recognition unit 264. Regarding the candidate object recognition result by the object recognition unit 262, for example, information of a bounding box including the recognized object and information indicating the name of the object are output. Incidentally, the above-mentioned information of the bounding box is composed of, for example, (x, y) coordinates of an upper-left vertex, the size of a horizontal width, and the size of a vertical width in the bounding box.

Meanwhile, the gaze point recognition unit 263 recognizes the gaze point (pointing with the index finger) by executing specified recognition processing on the input video upon completion and outputs joint information of the index finger as the gaze point recognition result to the integrated work recognition unit 264.

Then, the integrated work recognition unit 264 generates a vector indicating a pointing direction of the index finger (a pointing vector) from the index finger joint information obtained from the gaze point recognition unit 263 and searches for the target object which exists ahead of the pointing vector from the candidate object recognition result by the object recognition unit 262. Furthermore, the integrated work recognition unit 264 estimates the work item corresponding to the target object by searching the work list 310 using the relevant target object found by the search as a key and outputs this work item together with the completion time of day and the video upon completion.

FIG. 9 is an example of the video upon completion to explain the third variation. The image 360 illustrated in FIG. 9A and an image 370 illustrated in FIG. 9B are examples of the video upon completion extracted by the video extraction unit 250 and a front face of the outdoor unit 320 of the air conditioner is captured. By comparing the image 360 with the image 370, they have something in common, that is, the name plate 321 and the fans 322 appear in both the images, while their difference is that the worker's index finger 371 which points to the name plate 321 appears in the image 370.

Under this circumstance, both the name plate 321 and the fans 322 are target objects of the work, which are registered in the work list 310 illustrated in FIG. 2. Therefore, if the work recognition unit 260 is to recognize the work item when the image 360 illustrated in FIG. 9A is used as the video upon completion, it is difficult to recognize whether the relevant work is the work whose target object is the name plate 321 (the “the name plate work” of the work number “1”) or the work whose target object is the fans 322 (the “abnormal noise check of outdoor unit's fans” of the work number “2”). So, this variation is designed so that the worker points to the target object of the work as indicated in the image 370 in FIG. 9B when the work is completed. Then, if the work recognition unit 261 executes the aforementioned recognition processing when such image 370 is used as the video upon completion, the integrated work recognition unit 264 can: estimate that the name plate 321 which exists ahead of the pointing vector of the index finger 371 is the target object of the work; and recognize the corresponding “name plate work” of the work number “1.” Incidentally, if a plurality of objects exist ahead of the pointing vector in the video upon completion, an object with a close distance from the fingertip of the index finger 371 should preferably be prioritized and estimated as the target object of the work. Specifically speaking, if an object like the name plate 321 in FIG. 9B which overlaps with the fingertip of the index finger 371 exists, this object is prioritized most and estimated as the target object of the work.

Incidentally, in the above-described example, the explanation has been provided about the method of how the gaze point recognition unit 263 recognizes the image of pointing with the index finger as an example of the gaze point recognition; however, in this variation, the gaze point recognition method by the gaze point recognition unit 263 is not limited to this example. For example, the worker may wear eye tracking glasses capable of detecting the wearer's line of sight (visual point) and the gaze point recognition unit 263 may acquire line-of-sight coordinate information (x, y) at the completion time of day from the eye tracking glasses. In this case, the integrated work recognition unit 264 can identify the target object of the work by judging the bounding box including the line-of-sight coordinate information at the completion time of day by using the recognition result by the object recognition unit 262. Furthermore, without limitation to the method using the eye tracking glasses, a method of, for example, pointing, with light of a laser pointer or the like, to the target object at the time of the completion of the work and recognizing the object onto which the light is emitted may be also used.

Furthermore, as other gaze point recognition examples, gesture recognition of an action to surround the target object with fingers may be performed or the fingertip may be recognized by assigning a special mark to the tip of the index finger (for example, by changing colors only at the fingertip of a glove or printing a two-dimensional barcode). Furthermore, if there are a plurality of workers, the workers can be identified on the basis of differences in colors or differences in the two-dimensional barcode.

Moreover, regarding the explanation of the processing by the work recognition unit 260 and the work recognition unit 261, the method of identifying the object by using the object recognition model such as YOLO is indicated; however, the object recognition method according to the present invention is not limited to this example and various known methods for recognizing objects from a video(s) may be used. Specifically speaking, for example, the two-dimensional barcode may be pasted on all objects, which can be the target object of the work, in advance and the target object may be specified by identifying this two-dimensional barcode from the video upon completion.

### (1-3-4) Fourth Variation

In the aforementioned explanation of the work support system 200, the work recognition unit 260 estimates the work item by performing the object recognition with respect to the video upon completion extracted by the video extraction unit 250 from a video(s) recorded during the work and searching the work list on the basis of the target object recognition result. However, if a plurality of pieces of work with the same target object exist in the entire work, it is difficult to estimate the work item only with the target object recognition result. The fourth variation is effective in solving the above-described problem; and even if the work item cannot be narrowed down by using only the target object recognition result, the work item can be distinguished by making not only the target object recognition result, but also the completion utterance available for the estimation of the work item by the work recognition unit 260.

In the fourth variation, a completion utterance which should be uttered by the worker upon the completion of the work is determined in advance for each piece of the work. This completion utterance may not have to be different for all the work; however, different completion utterances are determined at least for the respective pieces of work having the same target object.

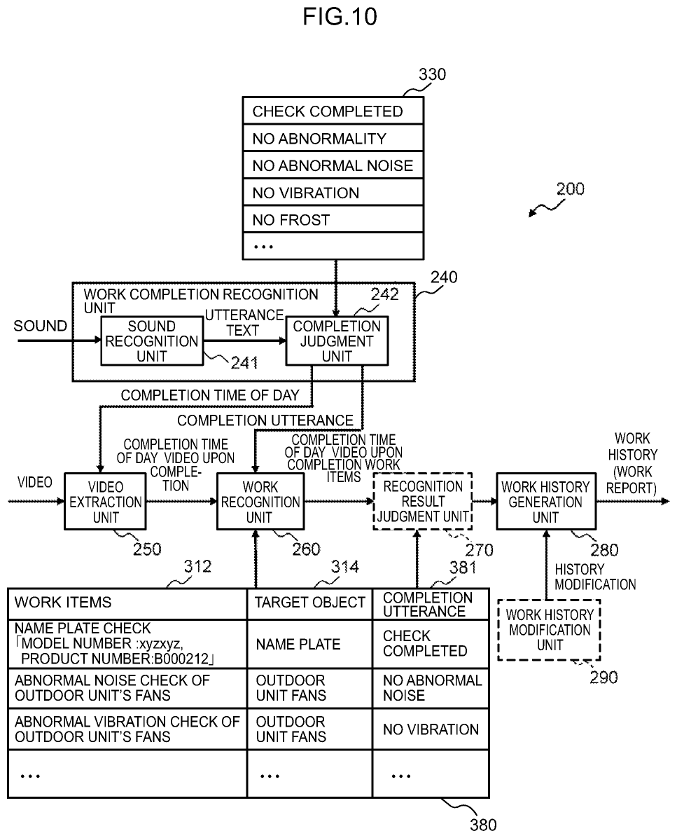

FIG. 10 is a diagram illustrating a flow of internal processing of a work support system according to the fourth variation. As compared to FIG. 5 explained in the first embodiment, FIG. 10 is characterized in that not only the completion time of day, but also the completion utterance(s) is output from the completion judgment unit 242. In the fourth variation, the completion judgment unit 242 outputs the completion utterance which has matched in a partial match retrieval between the utterance text and the completion utterance list 330, to the work recognition unit 260. Furthermore, a work list 380 illustrated in FIG. 10 is an example of the work list used in the fourth variation; and as compared to the aforementioned work list 310, a completion utterance 381 column indicating the completion utterance determined for each piece of work is added.

In the fourth variation configured as illustrated in FIG. 10, the work recognition unit 260 can identify the work item by searching the work list 380, using a combination of the target object, which has been recognized by the object recognition in the video upon completion, and the completion utterance which is input from the completion judgment unit 242, even if the plurality of pieces of work targeted at the same object exist.

Specifically speaking, for example, in the case of the work list 380 in FIG. 10, the target object for both the work item of the “abnormal noise check of outdoor unit's fans” and the work item of the “abnormal vibration check of the outdoor unit's fans” is the “outdoor unit's fans.” Under this circumstance, if the worker utters the completion utterance of “no abnormal noise” while watching the fans 322 of the outdoor unit 320, the work recognition unit 260 recognizes the fans 322 from the video upon completion and acquires the completion utterance of “no abnormal noise” from the completion judgment unit 242, so that by searching the work list 380 with the combination of the above, the completed work item can be identified as the “abnormal noise check of outdoor unit's fans.” On the other hand, if the worker utters the completion utterance of “no abnormal vibration” while watching the fans 322 of the outdoor unit 320, the work recognition unit 260 can identify the completed work item as the “abnormal vibration check of the outdoor unit's fans.”

According to the fourth variation described above, the work recognition unit 260 can distinguish the work item by making the types of the completion utterances available for the estimation of the work item even when the target object corresponding to the plurality of work items is recognized from the video upon completion; and, therefore, the effect of enhancing the work item recognition accuracy can be expected. Furthermore, according to the fourth variation, even if a plurality of target objects appear in the video upon completion and the work recognition unit 260 recognize the plurality of target objects, the work item can be distinguished by searching the work list 380 by combining the target objects and the completion utterances; and, therefore, the effect of enhancing the work item recognition accuracy can be expected.

### (2) Second Embodiment

Regarding a work support system 400 according to a second embodiment, the different from the work support system 200 according to the first embodiment will be mainly explained.

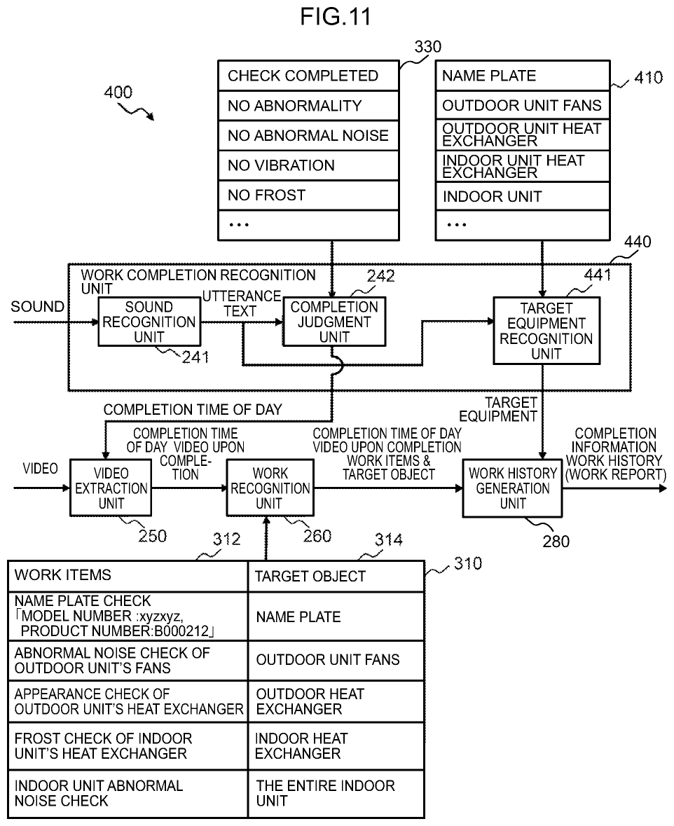

FIG. 11 is a diagram illustrating a flow of internal processing of the work support system according to the second embodiment. Referring to FIG. 11, the configuration of the work support system 400 is the same as that of the work support system 200, except that a target equipment list 410 is stored in the storage unit 220 and a work completion recognition unit 440 is included instead of the work completion recognition unit 240. Incidentally, the work support system 400 may include the recognition result judgment unit 270 and the work history modification unit 290 which are explained in the first embodiment as having the expansive functions and which are not illustrated in FIG. 11.

The target objects of the respective pieces of work are registered in the target equipment list 410 as illustrated in FIG. 11. Incidentally, in the following explanation, the target object(s) registered in the target equipment list 410 will be referred to as “target equipment” in order to notationally distinguish them from the “target object(s)” recognized by the object recognition by the work recognition unit 260 (the target object 314 in the work list 310); however, they substantially indicate the same things. Therefore, the target equipment list 410 can be generated by, for example, extracting the content described in the target object 314 of the work list 310 and is stored in the storage unit 220.

The work completion recognition unit 440 is configured by including the sound recognition unit 241, the completion judgment unit 242, and a target equipment recognition unit 441. The functions of the sound recognition unit 241 and the completion judgment unit 242 are as described earlier with reference to FIG. 5; however, in the second embodiment, the sound recognition unit 241 transmits the utterance text, which has been converted from the sound, not only to the completion judgment unit 242, but also to the target equipment recognition unit 441. Then, the target equipment recognition unit 441 has a function that: performs the partial match retrieval with the target equipment list 410 by using the utterance text which has been input from the sound recognition unit 241; and transmits information indicating matching target equipment to the work history generation unit 280 if the matching target equipment exists.

Incidentally, in the second embodiment, the worker is demanded to utter the target equipment of the work together with the completion utterance upon the completion of the work. Specifically speaking, for example, when the work of the name plate check is completed, the worker utters, for example, “the name plate check is completed.”

The sound collected during the work by the camera 110 is always input to the work completion recognition unit 440; and when the above-mentioned specific example is uttered, the sound recognition unit 241 converts the sound into an utterance text reciting “the name plate check is completed” and transmits this utterance text to the completion judgment unit 242 and the target equipment recognition unit 441.

Then, the completion judgment unit 242 to which the utterance text has been input judges the completion of the work by checking the partial match of the “check completed” via the partial match retrieval between the utterance text and the completion utterance list 330, decides the completion time of day, and transmits it to the video extraction unit 250. Furthermore, the target equipment recognition unit 441 to which the utterance text has been similarly input checks the partial match of the target equipment, that is, the “name plate” by means of the partial match retrieval between the utterance text and the target equipment list 410 and transmits this to the work history generation unit 280.

Meanwhile, the video extraction unit 250 to which the video(s) collected during the work by the camera 110 is input extracts the video upon completion on the basis of the completion time of day, which is input from the completion judgment unit 242, and transmits the extracted video upon completion together with the completion time of day to the work recognition unit 260. Then, the work recognition unit 260 performs the target object recognition with respect to the video upon completion received from the video extraction unit 250, identifies the work item by referring to the work list 310, and transmits it together with the completion time of day, the video upon completion, and the target object to the work history generation unit 280.

As a result of the above-described processing, the information indicating the target equipment is input from the target equipment recognition unit 441 to the work history generation unit 280 and the information indicating the completion time of day, the video upon completion, the work item, and the target object is input from the work recognition unit 260 to the work history generation unit 280. The work history generation unit 280 which has received these pieces of input information firstly judges whether or not the target equipment which is the recognition result by the target equipment recognition unit 441 matches the target object which is the recognition result by the work recognition unit 260.

If the target equipment matches the target object, the work history generation unit 280 clearly shows to the worker that the completion of the work has been successfully checked, for example, by outputting the sound stating “the name plate check has been completed with certainty” from the information presentation apparatus 120. In the second embodiment, by executing such processing, it is possible to make the worker recognize, at the time of the completion of each work, that the recognition processing which is required to prepare the work report of the relevant work has been executed normally, so that the worker can feel assured to proceed to the next work.

On the other hand, if the target equipment does not match the target object, the work history generation unit 280 feeds back the problem which has occurred when checking the completion of the work, for example, by outputting the sound, stating that “the video recognition result was a check of the heat exchanger; and was the name plate checked properly?,” from the information presentation apparatus 120. In the second embodiment, by executing such processing, the worker can be made become aware of a mistake of the work at an early stage when, for example, the work has been conducted by mistake; and it is thereby possible to prevent any omission or failure to conduct the work. As a result, the preparation of the highly-reliable work report can be expected.

### (3) Third Embodiment

Regarding a work support system 500 according to a third embodiment, the difference from the work support system 200 according to the first embodiment will be mainly explained. The work support system 500 according to the third embodiment can be applied to, for example, a case where an incentive according to the work (work item) conducted in the series of work is granted to the worker.

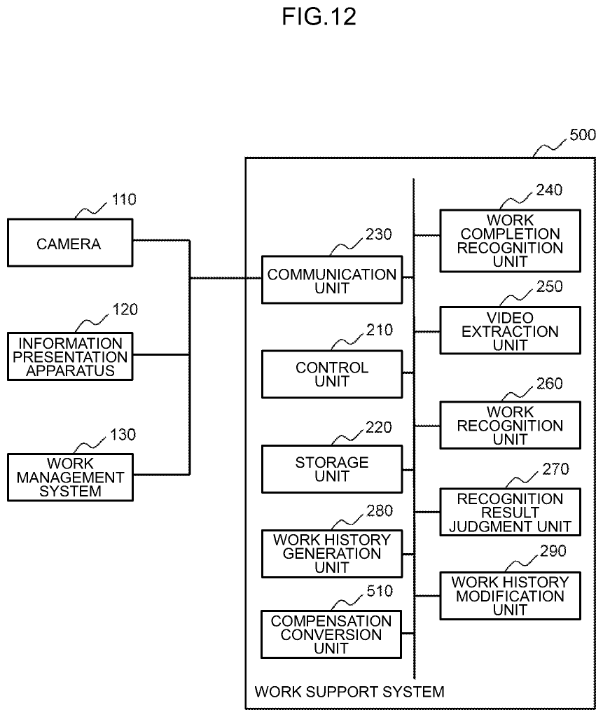

FIG. 12 is a block diagram illustrating a configuration example of the work support system according to the third embodiment. The work support system 500 is configured, as illustrated in FIG. 12, by adding a compensation conversion unit 510 to each configuration of the work support system 200 illustrated in FIG. 1.

The compensation conversion unit 510 has a function that calculates the incentive (compensation) to be granted to the worker according to the work completion status. The work support system 500 can, with the configuration explained in the first embodiment, recognize the work item which the worker has completed doing from among the plurality of work items included in the series of work. The compensation conversion unit 510 can calculate the incentive to be granted to the worker by referring to preset points of each work on the basis of the recognition result of this completed work item. The compensation conversion unit 510 can notify the worker of the current incentive by outputting the calculated incentive (which may be points or the like which have been earned for each work item) to, for example, the information presentation apparatus 120 every time the work item is completed.

Regarding the work support system 500 according to the above-described third embodiment, to conduct each work step with certainty upon performance of the series of work including the plurality of work steps (work items) would influence the worker's incentive, so that careful performance of the work can be promoted and, as a result, the enhancement of reliability in maintenance work, etc. can be expected. Conventionally, there have been workers at the site of, for example, the maintenance work including a plurality of work steps, who emphasize how fast they can finish the work, and try to go to the next site without carefully checking in each work step; however, the work support system 500 according to the third embodiment can assist solving such a problem.

Incidentally, the points are mentioned in the above explanation as one example of the means of expressing the incentive; however, such means is not limited to this example in the third embodiment as long as it is the means capable of enhancing the worker's motivation. For example, the points may be converted to the amount of money or may be used for the evaluation of the worker(s) by the work administrator.

Furthermore, in the third embodiment, a method for granting the points is not limited to a specific method. For example, the points may be set and granted for each work registered in the work list 310; or even if the relevant work is not registered in the work list 310, specified points may be granted to the performance of the work which deserves to be evaluated. The “work which deserves to be evaluated” includes, for example, work to check signs which might result in failures (specifically speaking, to check whether there are any small cracks in each target equipment, to check whether any obstacle is placed in front of the outdoor unit, to pull up weeds around the outdoor unit, and so on). Accordingly, the enhancement of the worker's motivation and the enhancement of the service quality can be expected by making it possible to also grant the points to the work which is not included in the original work steps.

### (4) Fourth Embodiment

Regarding a work support system 600 according to a fourth embodiment, the difference from the work support system 200 according to the first embodiment will be mainly explained.

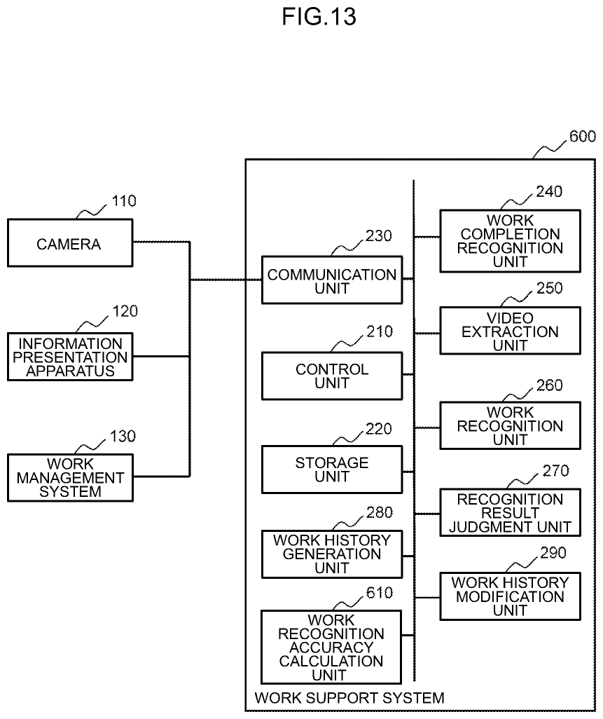

FIG. 13 is a block diagram illustrating a configuration example of the work support system according to the fourth embodiment. The work support system 600 is configured, as illustrated in FIG. 13, by adding a work recognition accuracy calculation unit 610 to each configuration of the work support system 200 illustrated in FIG. 1. The work support system 600 can, with the configuration explained in the first embodiment, recognize the work item which the worker has completed doing from among the plurality of work items included in the series of work. With regard to the recognition result of this work item, the work recognition accuracy calculation unit 610 has a function that calculates and outputs probability of the work content.

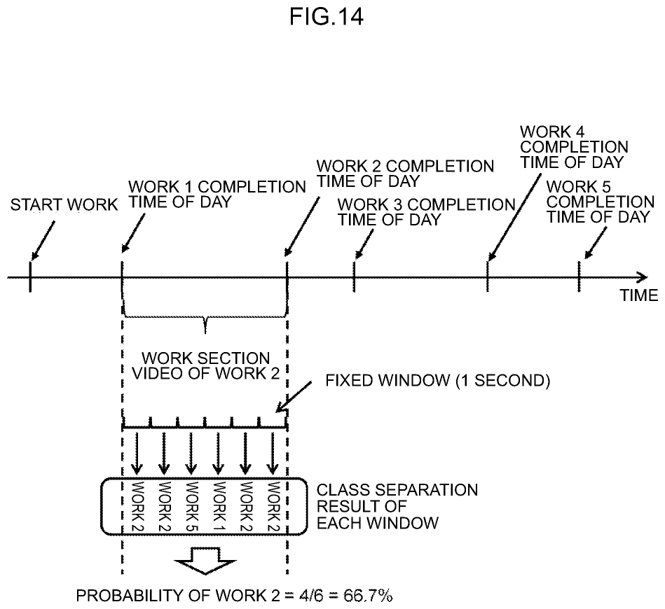

FIG. 14 is a diagram for explaining a probability judgment of the work content according to the fourth embodiment. FIG. 14 illustrates an image of the work recognition accuracy calculation unit 610 calculating the probability of the work content by taking work 2 as an example while the series of work including work 1 to work 5 is conducted. Under this circumstance, the work 1 to the work 5 illustrated in FIG. 14 correspond to the work #1 to the work #5 of the work list 310 illustrated in FIG. 2. Specifically speaking, the work 2 corresponds to the work #2 of the “abnormal noise check of outdoor unit's fans” in the work list 310.

When the completion utterance of the work 2 is uttered at the completion time of day of the work 2, the work support system 600 recognizes the completion of the work 2 by having the aforementioned respective units execute the processing. Under this circumstance, the work recognition accuracy calculation unit 610 extracts a video of a section in which the work item regarding which the completion has been recognized (a work section video of the work 2) from the video(s) collected by the camera 110, calculates the probability of the work content in the procedures explained in the next and subsequent paragraphs, and outputs the calculation result. Incidentally, referring to FIG. 14, it is obvious that the work 2 was conducted during a period of time after the completion time of day of the work 1 until the completion time of day of the work 2; and it is only necessary for the work recognition accuracy calculation unit 610 to extract the video recorded during this section as the work section video of the work 2.

Firstly, the work recognition accuracy calculation unit 610 prepares a window of a specified fixed number of seconds (for example, 1 second) and acquires a video group of the work 2 (for example, 30 images in a case of 30 fps) by shifting the window from a start position for every designated amount of seconds (for example, 1 second) with respect to the work section video of the work 2.

Next, the work recognition accuracy calculation unit 610 inputs the acquired video group of the work 2 to a class separation model to classify it into the work 1 to the work 5, and performs class separation. As a result, each image included in the video group of the work 2 is classified into any one of the classes of the work 1 to the work 5. A possible method of the above-described class separation is, for example, a method of the class separation in an NN (Neural network) by using a feature amount vector, which is converted to a feature amount via an Auto Encoder or the like, with the class separation model; however, the class separation method is not limited to this example and a feature vector may be formed by using an LSTM (Long Short Term Memory) or pixel values of each image may be directly used as (or reduced to) the feature vector.

Next, the work recognition accuracy calculation unit 610 calculates the probability of the work content of the work 2 from a ratio of the class separation result of each window. For example, FIG. 14 illustrates the example where the one-second fixed window is used and is shifted every second with respect to the 6-second work section video of the work 2; and under this circumstance, six windows are acquired as the video group of the work 2. Then, as a result of performing the class separation on each of these six windows, they are classified to two pieces of the work 1, four pieces of the work 2, and one piece of the work 5, so that the probability of the work content being the work 2 can be calculated as “4/6(≈66.7%).” Therefore, in this case, the work recognition accuracy calculation unit 610 outputs the probability of 66.7%. The result of the class separation indicates the classification to find to which work content of the work the content of the video (image) acquired in each window is similar. So, when the classification result of the work 2 is small, the value of the probability becomes small and this shows that the reliability with respect to the actual performance of the work content of the work 2 is low. On the other hand, if the classification result of the work 2 is large, the value of the probability becomes large and this shows that the reliability with respect to the actual performance of the work content of the work 2 is high.

In this embodiment, an output destination of the probability of the work content which is calculated by the work recognition accuracy calculation unit 610 is not particularly limited and, for example, the probability of the work content may be output to the work history generation unit 280 and the work history generation unit 280 may link the probability of the work content to the work item when preparing the work report. In this case, as the work report is transmitted to the information presentation apparatus 120 and the work management system 130, the worker and the work administrator can check the reliability of the work of the linked work item. Incidentally, the probability of the work content may be saved as information which can be browsed only by the work administrator without being presented to the worker. When this is done, the work administrator can effectively carry out the check to see if the work has been conducted appropriately, while reducing the check time, by viewing the video (evidence) attached to the work report with respect to the work item of low probability.

Furthermore, in this embodiment, the reliability of the conducted work item may be judged by comparing the probability of the work content calculated by the work recognition accuracy calculation unit 610 with a preset threshold value. Then, if the probability is equal to or smaller than the threshold value, the enhancement of the effect of, for example, monitoring the worker can be expected by checking with the worker by outputting, for example, “Have you really conducted the work?” in real time from the information presentation apparatus 120.

Incidentally, this embodiment may be designed so that the calculation of the probability of the work content by the work recognition accuracy calculation unit 610 may not be executed in real time; and, for example, when the preparation of the work report has been completed with respect to all the work items, the work recognition accuracy calculation unit 610 may be operated to calculate the probability of the work content with respect to each work item. By shifting the processing timing as described above, it is possible to avoid concentration of the processing load in the work support system 600. Furthermore, since it is possible to avoid the occurrence of waiting time for the probability calculation result during the work, the effect of not intervening the progress of the worker's work can also be expected.

The embodiments and variations of the present invention have been explained above; however, they have been described in detail in order to explain the present invention in an easily comprehensible manner and is not necessarily limited to the embodiment having all the configurations explained above. Furthermore, part of the configuration of a certain embodiment or variation can be replaced with the configuration of another embodiment or variation and the configuration of another embodiment or variation can be added to the configuration of a certain embodiment or variation. Furthermore, another configuration can be added to, deleted from, or replaced with part of the configuration of each embodiment or variation.

For example, the first embodiment is designed so that: the live sound collected by the camera 110 during the work is input to the work support system 200; and as triggered by finding the completion utterance in the utterance text which is obtained by converting the above-mentioned sound into the text, the completion of each work is recognized and the recognition of the relevant work is started. However, the information which is input to the work support system according to the present invention may be any information as long as the completion of each work can be determined at least from the worker's behaviors; and such information is not limited to the live sound and may be, for example, sound data obtained by converting the live sound into a digital signal or sound data which is generated artificially. In other words, the work support system according to the present invention can recognize the completion of the work on the basis of the sound data collected during the work. Regarding a possible specific example of the above-mentioned artificially generated sound data, the worker may be made to wear a dedicated device for recognizing movements of their mouth (which may be, for example, muscle movements around their mouth) and this dedicated device may generate the artificial sound data from the movements of the worker's mouth and input the generated sound data to the work support system. This configuration is particularly effective when conducting the work at a site where it is difficult to collect the sound due to, for example, loud surrounding noise; and even if the worker utters the completion utterance voicelessly, the work support system can determine the completion of each work.

Furthermore, for example, the work support system according to the present invention may be designed to determine the completion of each work on the basis of the video(s) collected by the camera 110 instead of the sound or the sound data. Specifically speaking, for example, if the worker is made to perform a specified movement (such as shaking their head or some gesture) to express the completion of the work at the time of the completion of each work, the work support system can determine the completion of each work by analyzing the video(s) collected by the camera 110 and recognizing the above-mentioned head-shaking movement or gesture. In the case of such configuration, the work support system 200 according to the first embodiment can recognize the completion of the work and the work item and automatically prepare the work report even if the camera 110 does not collect the sound (or the sound data).

Furthermore, for example, the first embodiment is described in such a manner that the recognition result judgment unit 270 may use the OCR function or the like and read the information such as the meter values and the model number, etc. of the name plate which are shown in the video upon completion; and furthermore, the information which is read from the video upon completion the work history generation unit 280 may be described in the work report 350. Since specific numerical value data can be recorded as evidence by executing the above-described processing, the reliability of the work report can be further enhanced.

Moreover, if a maintenance target component is equipped with a sensor capable of acquiring the status of the component and the sensor is connected to a network, sensor data of the work completion time of day which has been output from the completion judgment unit 242 may be acquired via the network and the sensor data may be recorded. For example, if a meter is equipped with a sensor which outputs meter values, a meter value of the work completion time of day can be acquired and recorded as the sensor data. Furthermore, for example, the fans 322 are equipped with a sensor which acquires a voltage, time-series voltage data around the work completion time of day can be acquired as the sensor data and can be compared with a normal state to judge whether the voltage data is normal or abnormal, and the judgement result can also be recorded.

Furthermore, each of the aforementioned configurations, functions, processing units, processing means, etc. may be implemented by hardware by, for example, designing part or all of such configurations, functions, processing units, and processing means by using integrated circuits or the like. Moreover, each of the aforementioned configurations, functions, etc. may be implemented by software by processors interpreting and executing programs for realizing each of the functions. Information such as programs, tables, and files for realizing each of the functions may be retained in memories, storage devices such as hard disks and SSDs (Solid State Drives), or storage media such as IC cards, SD cards, and DVDs.

Furthermore, control lines and information lines which are considered to be necessary for the explanation are illustrated in the drawings; however, not all control lines or information lines are necessarily indicated in terms of products. Practically, it may be assumed that almost all components are connected to each other.

### REFERENCE SIGNS LIST

110: camera
120: information presentation apparatus
130: work management system
200, 400, 500, 600: work support system
210: control unit
220: storage unit
230: communication unit
240, 440: work completion recognition unit
241: sound recognition unit
242: completion judgment unit
250: video extraction unit
260, 261: work recognition unit
262: object recognition unit
263: gaze point recognition unit
264: integrated work recognition unit
270: recognition result judgment unit
280: work history generation unit
290: work history modification unit
310, 380: work list
320: outdoor unit
321: name plate
322: fans
323: heat exchanger
330: completion utterance list
340, 360, 370: images
350: work report
410: target equipment list
441: target equipment recognition unit
510: compensation conversion unit
610: work recognition accuracy calculation unit

1. A work support system for preparing a work report by using information including at least a video collected while conducting work,
the work support system comprising:
a work completion recognition unit that judges a completion of the work from the information and recognizes completion time of day of the work;
a video extraction unit that extracts a video upon completion of the work from the video with reference to the completion time of day of the work;
a work recognition unit that recognizes a work item or work items of the work by using the video upon completion of the work which is extracted by the video extraction unit; and
a work history generation unit that generates a work history of the work in the work report on the basis of recognition results by the work completion recognition unit and the work recognition unit.

2. The work support system according to claim 1,
wherein the information collected while conducting the work includes the video and sound data; and
wherein the work completion recognition unit judges the completion of the work by identifying a specified utterance from the sound data and recognizes a timing when the specified utterance was performed, as the completion time of day of the work.

3. The work support system according to claim 1,
wherein the video upon completion or a part thereof which is used by the work recognition unit to recognize the work item of the work is incorporated into the work history of the work.

4. The work support system according to claim 1,
wherein when a series of work including a plurality of pieces of the work of the work items which are different is conducted,
regarding each of the plurality of pieces of the work,
every time the work completion recognition unit judges the completion of one piece of the work from the information collected through the series of work and recognizes the completion time of day of the work, the video upon completion of the work is extracted by the video extraction unit and the work items of the work are recognized by the work recognition unit; and
wherein the work history generation unit generates the work history of the work in the work report on the basis of the recognition results regarding the work by the work completion recognition unit and the work recognition unit.

5. The work support system according to claim 4,
wherein the work history generation unit outputs specified presentation information based on the work history every time it generates the work history of the work in the work report.

6. The work support system according to claim 5,
further comprising a work history modification unit that modifies the work report in accordance with a modification instruction,
wherein the work history modification unit adds a modification record to the work history of the work, which is a modification target, when modifying the work report.

7. The work support system according to claim 1,
further comprising a recognition result judgment unit that judges whether the video upon completion which is used by the work recognition unit to recognize the work item is appropriate as a video indicating the work of the work item.

8. The work support system according to claim 1,
wherein a model video is retained in advance as an optimum video recording when the work is completed; and
wherein the video extraction unit extracts, as the video upon completion, a video with high similarity to the model video within a specified time width with reference to the completion time of day from the video collected while conducting the work.

9. The work support system according to claim 2,
wherein the work recognition unit recognizes the work item of the work on the basis of a combination of a target object of the work recognized from the video upon completion and the specified utterance identified by the work completion recognition unit.

10. The work support system according to claim 1,
wherein the work recognition unit:
recognizes one or more objects and a specified gaze point, which are included in the video upon completion, by executing specified recognition processing on the video upon completion;
specifies a target object of the work on the basis of the gaze point from among the recognized one or more objects; and
recognizes the work item of the work on the basis of the specified target object.

11. The work support system according to claim 2,
wherein the work completion recognition unit judges the completion of the work and recognizes the completion time of day of the work by identifying the specified completion utterance indicating the completion of the work from the sound data and recognizes target equipment of the work by identifying an utterance indicating the target equipment of the work from the sound data;
wherein the work recognition unit recognizes the work item of the work on the basis of a target object of the work which is recognized from the video upon completion; and
wherein when generating the work history of the work, the work history generation unit compares the target object of the work, which is recognized by the work recognition unit, with the specified target equipment recognized by the work completion recognition unit to see if the target object of the work matches the specified target equipment or not.

12. The work support system according to claim 1,
further comprising a work recognition accuracy calculation unit that calculates probability as work content of the work item from the video collected while conducting the work, with respect to the work regarding which the work item is recognized by the work recognition unit.

13. The work support system according to claim 4,
further comprising a compensation conversion unit that calculates an incentive granted to a worker according to a completion status of each piece of work when the plurality of pieces of the work are conducted in the series of work.

14. A work support method for preparing a work report by using information including at least a video collected while conducting work,
the work support method comprising:
a work completion recognition step of judging a completion of the work from the information and recognizing completion time of day of the work;
a video extraction step of extracting a video upon completion of the work from the video with reference to the completion time of day of the work;
a work recognition step of recognizing a work item or work items of the work by using the video upon completion of the work which is extracted in the video extraction step; and
a work history generation step of generating a work history of the work in the work report on the basis of recognition results of the work completion recognition step and the work recognition step.
